(19) United States
(12) Patent Application Publication
(10) Pub. No.: US 2014/0128543 A1
(43) Pub. Date: May 8, 2014

(54) METHODS OF MAKING POLYURETHANE COATED ARTICLES, AND ARTICLES MADE THEREFROM

(71) Applicant: SABIC INNOVATIVE PLASTICS IP B.V., Bergen op Zoom (NL)

(72) Inventors: David Dean Clinnin, Newburgh, IN (US); Michael Matthew Laurin, Pittsfield, MA (US); Michael J. Davis, Mt. Vernon, IN (US)

(73) Assignee: SABIC INNOVATIVE PLASTICS IP B.V., Bergen op Zoom (NL)

(21) Appl. No.: 13/672,361

(22) Filed: Nov. 8, 2012

(51) Int. Cl. C09D 175/04

(52) U.S. Cl. CPC C09D 175/04
USPC 524/871; 427/393.5

(57) ABSTRACT

A method of making a polyurethane coating can comprise: mixing an unblocked isocyanate component with a polyol component in the presence of a hydroxyl-free solvent and a catalyst to form a reaction mixture; depositing the reaction mixture onto a polymer substrate; and curing the reaction mixture on the substrate to form a polyurethane coated substrate. The polyurethane coated substrate can have a percent thinning of greater than or equal to 10%, e.g., without cracking or delamination when measured on a rectangular block having 90° angles.

### TECHNICAL FIELD

This disclosure relates generally to the formation of diols and polyols and the formation of polyurethanes therefrom.

### BACKGROUND

Polyurethanes have been used as hard coatings to protect polymers and glass, because of their scratch and water resistant properties. Polyurethanes are generally prepared by reacting a polyol or polyol based compound with an isocyanate, typically in the presence of a catalyst. In order to address limitations and stability problems in the synthesis, the isocyanates are generally blocked with a blocking agent, in which at least one isocyanate group has reacted with a protecting or blocking agent to form a derivative which will dissociate on heating to remove the protecting or blocking agent and release the reactive isocyanate group. The reactive isocyanate group is then available to react with the active groups of the polyols to achieve polymerization of the polyurethane. Because of the blocked chemistry, the reaction requires both heating and longer reaction times in order to proceed.

In sheet applications, polyurethane coatings are generally applied to a flat piece or, at best, a gently curved final part prepared by injection molding or thermoforming via techniques such as flow or dip coating that are performed under yellow light (low ultraviolet) to minimize deblocking prior to curing, followed by curing with either heat or actinic energy. In order to obtain 2.5 dimensional (D) or 3D parts the thermopolymer would be first formed into the proper shape and then post-coated and cured to create the end product for a given application. For any application using a process such as in-mold decoration (IMD), the part would have to be prepared and then post-coated and cured appropriately. These techniques have the disadvantage of being time intensive, whereby the blocked chemistry of the isocyanates is inherently slow and for processes such as dip-coating, there is the added time of as much as one hour to apply the coating to the substrate before curing is even initiated. Furthermore, many such coatings are not capable of withstanding the thermoforming application without cracking or debonding.

Thus, there remains a need in the art for thermopolymer compositions having an improved balance of scratch, fog, and/or chemical resistance and also for a process of applying such a coating to a substrate with reduced application and curing times.

### BRIEF SUMMARY

Disclosed herein are methods for making formed polyurethane coated substrates, and articles made therefrom.

In an embodiment, a method of making a polyurethane coating can comprise: mixing an unblocked isocyanate component with a polyol component in the presence of a hydroxyl-free solvent and a catalyst to form a reaction mixture; depositing the reaction mixture onto a polymer substrate; and curing the reaction mixture on the substrate to form a polyurethane coated substrate. The polyurethane coated substrate when formed over a rectangular block having 90° angles, a percent thinning of greater than or equal to 10%.

In an embodiment, a method of making a polyurethane coated substrates can comprise: mixing an unblocked isocyanate component with a polyol component in the presence of a hydroxyl-free solvent and a catalyst to form a reaction mixture; depositing the reaction mixture onto a polymer substrate; curing the reaction mixture on the substrate to form a polyurethane coated substrate; and thinning the polyurethane coated substrate, wherein the polyurethane coated substrate is thinned by greater than or equal to 10%.

The above described and other features are exemplified by the following detailed description.

### DETAILED DESCRIPTION

The present disclosure relates to polyurethane coatings also referred to as “coating(s)” and/or “composition” and methods of making and using a modified two-component polyurethane coating as a thermoformable coating applied to various substrates for molding applications (e.g., thermoforming, drapeforming, pressure forming, and in-mold decoration (IMD), such as with standard injection molding or with injection compression). The coating is applied to the substrate via any suitable technique. In particular, the method of making polyurethane coatings involves a two-component injection method that takes advantage of the speed of reaction involved in unblocked isocyanate chemistry for application to a substrate via a roll coating. This method can allow for improved application rates, polymerization and curing times, better cure kinetics (resulting in a higher molecular weight polymer), and can ultimately result in coatings that have the advantage of improved chemical, fog, and/or abrasion resistance. Specifically, the coating can have antifog properties and can have chemical and/or arasion resistance, thereby rendering the coating useful in a greater number of application where antifog coatings were previously unavailable, e.g., due to their lack of abrasion resistance. Such coatings can be used, for example, in 3D molding or in-mold decoration for use in industries such as in the automotive/transportation industries (in parts such as interior paneling, heating ventilation and air conditioning panels, windows, and the stick shift paneling), in personal eye protection industry, in instrument gauges or clusters, in hand held electronics and in other areas where such properties are beneficial. Articles envisioned include articles where the film is placed in the cavity of an injection molding tool, on the core of an injection molding tool, or on both the core and cavity of an injection molding tool and then the resin injected onto the film or between the two films.

### The Polyurethane Coating

The composition of the polyurethane coating typically comprises residues of an isocyanate prepolymer with reactive, unblocked isocyanate groups (also referred to as the isocyanate component) and a polyol (also referred to as the polyol component). Desirably, greater than or equal to 85% of the isocyanate groups are unblocked, specifically, greater than or equal to 90% of the isocyanate groups are unblocked, more specifically, greater than or equal to 95% of the isocyanate groups are unblocked, and yet more specifically, greater than or equal to 99% of the isocyanate groups are unblocked. The isocyanate prepolymer can have 100% of the isocyanate groups unblocked and be packaged under dry conditions and nitrogen to prevent moisture contamination which would cause some of the unblocked groups to react. The system can further comprise, an emulsifier, a coalescent, a catalyst, and various additives. The reaction to form the polyurethane coatings of the isocyanate and the polyol forms a part hydrophilic, part hydrophobic polyurethane composition when reacted and cured under particular conditions, in the presence of an appropriate organic solvent. It has been discovered that by varying the type of isocyanate, the type and molecular weight of the polyol, the percent solids of the material and the catalyst, the scratch, fog, and chemical resistance, the efficacy, and other physical and chemical properties can be varied. The present coatings can be thermoformed without cracking or debonding, thereby making them particularly useful in manufacturing processes, especially when the final article is a three dimensional (3D) structure.

The coating of the present application can have one or more of improved: chemical resistance, time to fog, delta haze after Taber, pencil hardness, fog behavior at saturation, and/or percent thinning, as compared to VISGARD* coating (commercially available from FSI Coating Technologies, Irvine, Calif.). Specifically, the coating can have time to fog values at 50% relative humidity at a temperature of −30° F. (−34° C.) to 110° F. (38° C.) of greater than 30 seconds, more specifically, greater than or equal to 60 seconds, and more specifically, greater than or equal to 110 seconds. The coating can have delta haze after Taber (an abrasion resistance test) values of less than or equal to 10%, more specifically, less than or equal to 6%. As used herein, Taber delta haze is determined using CS-10F wheels, a 500 gram (g) load, and 100 cycles as specified by ASTM D1044-08. The coating can have pencil hardness values of F or better as measured according to ASTM D3363-92a. The coating can have a haze of less than or equal to 1.5%, specifically, less than or equal to 0.5%, and more specifically, less than or equal to 0.3%, as determined according to ASTM D1003-11, Procedure A, CIE illuminant C, using a Gardner Haze Guard Dual meter. The percent thinning of the composition can be greater than or equal to 10%, specifically, greater than or equal to 15%, more specifically, greater than or equal to 23%, still more specifically, greater than or equal to 35%, and even greater than or equal to 50%. Percent thinning is measured by recording the thickness of the product before forming, recording the thickness of the product after forming, and then using the following calculation to describe the percent thinning:

$$percent thinning = ( \frac{original thickness - thickness after forming}{original thickness} ) \times 100$$

The polyurethane coating comprises derivatives of an unblocked isocyanate, a polyol, and a residual amount of a catalyst. These materials and the method of making the coating are described in more detail below.

### Isocyanates

Typically, the isocyanate prepolymers used to prepare the coatings contain 2 or 3 isocyanate groups, although more groups are acceptable. Examples of isocyanate systems include a biuret or an isocyanurate of a diisocyanate, triisocyanate, or polyisocyanate. Typical diisocyanates prepolymers that can be used are aliphatics including cycloaliphatic, aromatic, heterocyclic, and mixed aliphatic aromatic polyisocyanates containing 2, 3 or more isocyanate groups.

More specifically, isocyanates can include, but should not be limited to, hexamethylene diisocyanate, diisophorone diisocyanate, toluene diisocyanate, diphenylmethane diisocyanate, bis(methylcyclohexyl)diisocyanate, and combinations comprising at least one of the foregoing isocyanates, such as hexamethylene diisocyanate and combinations comprising hexamethylene diisocyanate. The isocyanate can also be a biurate, e.g., defined as the partial reaction of a polyisocyanate with hydroxyl or amine components to increase terminal isocyanate groups. Examples of possible isocyanates include those listed as DESMODUR* tradenames (commercially available from Bayer Material Science, Pittsburgh, Pa.) can also be used, including, DESMODUR 75*, which is a hexamethylene diisocyanate.

Other examples of possible isocyanate compounds include, for example, ethylene diisocyanate, propylene diisocyanate, tetramethylene diisocyanate, decamethylene diisocyanate, dodecamethylene diisocyanate, 2,4,4-trimethylhexamethylene-1,6-diisocyanate, phenylene diisocyanate, tolylene or naphthylene diisocyanate, 4,4′-methylene-bis-(phenyl isocyanate), 4,4′-ethylene-bis-(phenyl isocyanate), omega (ω),ω-diisocyanato-1,3-dimethyl benzene, ω,ω′-diisocyanato-1,3-dimethylcyclohexane, 1-methyl-2,4-diisocyanato cyclohexane, 4,4′-methylene-bis-(cyclohexyl isocyanate), 3-isocyanato-methyl-3,5,5-trimethyl cyclohexyl isocyanate, dimer acid diisocyanate, ω,ω′-diisocyanato-diethyl benzene, ω,ω′-diisocyanatodimethyl cyclohexyl benzene, ω,ω′-diiso-cyanatodimethyl toluene, ω,ω′-diisocyanato-diethyl toluene, fumaric acid-bis-(2-isocyanato ethyl)ester or triphenylmethane-triisocyanate, 1,4-bis-(2-isocyanato prop-2-yl)benzene, and 1,3-bis-(2-isocyanato prop-2-yl)benzene, as well as combinations comprising at least one of the foregoing isocyanates. Typically, the isocyanates that are used have low average molecular weight (Mw) of 168 grams per mole (g/mol), e.g., hexamethylene diisocyanate and toluene diisocyanate.

Use can also be made of polyisocyanates obtained by reaction of an excess amount of the isocyanate with a) water, b) a lower molecular weight polyol (e.g. weight average molecular weight of less than or equal to 300 g/mol, and/or c) a medium weight average molecular weight polyol, e.g. a polyol of greater than 300 and less than 8,000 g/mol, for example sucrose, or by the reaction of the isocyanate with itself to give an isocyanurate. The lower molecular weight polyol comprises, for example, ethylene glycol, propylene glycol, 1,3-butylene glycol, neopentyl glycol, 2,2,4-trimethyl-1,3-pentane diol, hexamethylene glycol, cyclohexane dimethanol, hydrogenated bisphenol-A, trimethylol propane, trimethylol ethane, 1,2,6-hexane triol, glycerine, sorbitol, pentaerythritol, as well as combinations comprising at least one of the foregoing polyols.

### Polyols

Polyols can be characterized by their hydroxyl equivalent weight, which is equal to the average molecular weight divided by the number of equivalent hydroxyl groups. In some embodiments, polyols have hydroxyl equivalent weights of greater than or equal to 100, specifically 150 to 900 grams of polyol per gram equivalent of hydroxyl. The polyols can have a weight average molecular weight (Mw) of greater than or equal to 90, specifically, 90 to 30,000 g/mole, more specifically, 600 to 12,000 g/mol, still more specifically, 600 to 4,000 g/mol, and yet more specifically, 800 to 1,500 g/mol. Polyols can be straight, branched, or cyclic. They can be a water-soluble or water dispersible polyol.

While a very wide variety of polyols can be used, the typical system will employ at least one of polyalkylene glycols (e.g., polyethylene glycols, polypropylene glycols, and combinations comprising at least one of the foregoing), water soluble triols, tetrahydroxy-functional branched ethylene oxide/propylene glycol copolymers, block polymers thereof, as well as combinations comprising at least one of the foregoing polyols. Other variations include water soluble triols or glycerin polymers and other multi-functional, branched polyhydroxyl compounds such as tetrahydroxy functional copolymer of ethylene oxide and propylene glycol, and/or block polymer combinations of any of the above. Tetrahydroxy functional branched/ethylene oxide/propylene glycol co-polymers can also be used. Block polymers of polyalkylene glycols, and more particularly, block polymers of polyethylene glycol and polypropylene glycols may be used. Even more particularly, polyethylene-90 or polyethylene-180 may be used. Polyoxyethylene glycols can also be employed. Combinations comprising any of the foregoing polyols can also be employed.

### Catalysts

Catalysts can optionally be employed in conjunction with the coatings of the present application. When used, a wide variety of catalysts that facilitate the reaction can be employed. For example, catalysts such as amines (such as tetramethylbutanediamine, triethylene diamine); azines (such as 1,4 diaza(2,2,2)bicyclooctane); and organotin compounds (such as tinoctoate); as well as combinations comprising at least one of the foregoing catalysts. These catalysts can be used to complete the cure of the mixture. Desirably, the catalyst comprises tin, such as dibutyl tin dilaurate.

Catalysts in polyurethane polymerizations can be used in low concentrations (e.g., 0.10 wt % to 1.2 wt %, specifically, 0.25 wt %, based upon a total weight of solids in the reaction mixture) e.g., in order to extend the pot life of the isocyanate/polyol reaction. Optionally, the catalyst levels can be increased to increase the cure kinetics of the polyurethane. Increasing the cure kinetics can result in at least one of higher toughness, increased scratch, fog, and/or chemical resistance. In some embodiments the catalyst is present in an amount of greater than 0.1 wt %, specifically 0.1 to 2 wt %, and more specifically, 0.14 wt % to 1.3 wt %, and yet more specifically, 0.5 wt % to 1.2 wt %, based upon a total weight of solids in the reaction mixture. Generally, where a haze of less than 1.5% is desirable, catalyst levels are less than or equal to 1.4 wt % based upon a total weight of solids in the reaction mixture, specifically, less than or equal to 1.3 wt %, since the resultant haze of the coatings was observed to increase with increasing catalyst.

### Solvents

The mixtures can comprise solvent(s). In the polymerization of polyurethanes in blocked chemistries, hydroxyl groups are acceptable in the solvent as the hydroxyl groups will not immediately react. Solvents that can be used in such blocked chemistries, such as diacetone alcohol, can be chosen on their effect on the polymer (e.g., on how polymer friendly they are) and whether or not they will swell or induce haze in the polymer substrate that is being coated.

As the polymerization of the polyurethanes occurs under unblocked isocyanate conditions, the solvent for use in the present mixtures can be necessarily hydroxyl-free, and desirably a fast evaporating solvent. Desirably, the solvent comprises a ketone, specifically methyl ethyl ketone. Ketones are generally avoided as solvents in polyurethane coating applications as they are known to be polymer-aggressive and can cause crazing, cracking, and hazing of polymer substrates, even with limited contact times. However, due to the very short contact time of the coating prior to baking, the amount of solvent strike-in that can occur (e.g., in the polycarbonate) is reduced.

Examples of possible coating packages include: Exxene HCAF 100, Exxene HCAF 424, Exxene HCAF 506, Exxene HCAF 550, Exxene HCAF 560, Exxene HTAF 100, Exxene HTAF 308, Exxene HTAF 401, Exxene HTAF 601, etc., from Exxene, Corpus Christi, Tex., and VISGARD* and VISTEX* Anti-fog coating packages from FSI Coating Technologies, Irvine, Calif. Each of these packages includes two components, Component A (isocyanate package) and Component B. If the isocyanate package does not have greater than or equal to 90% unblocked isocyanate (based upon the total isocyanate in the package), then Component A needs to be changed or modified to be the unblocked version of that isocyanate. Optionally, Component B can be employed with any of the unblocked isocyanates set forth above (e.g., hexamethylene diisocyanate) wherein greater than or equal to 90% of the isocyanate is unblocked. Optionally, the unblocked isocyanate can be solvated with a ketone such as methy ethyl keytone/methyl isobutyl ketone. Some other coating packages may be disclosed in US Patent Publication 2004/0137155 A1 to Bernheim et al. and U.S. Pat. No. 5,877,254 to La Casse et al. Again, for these coating packages, the isocyanate would be used in an unblocked form with greater than or equal to 90% of the isocyanate being unblocked.

### Substrate

For example, the substrates can be films (also referred to as sheets), and can be formed by any method for making such films (such as casting, extrusion, pultrusion, etc.). These films, once coated, can be further processed to form 3D articles using methods such as thermoforming (e.g., accuforming), drape forming, embossing, pressure assist forming, high pressure forming, hydroforming, pressure forming (also known as Niebling). Optionally the 3D articles can be used as inserts in an injection molding tool and then have resin injected onto them to create additional structure in what is commonly called in-mold decoration, in-mold labeling, or film insert molding. Optionally, the films can be multilayer, e.g., formed by co-extrusion and/or lamination processes. Similarly, oriented films can be used. Oriented films can be used, for example, to reduce shrinkage of the substrate during post processing steps, e.g., that use elevated temperatures below the heat deflection temperature of the material like printing.

The films, once coated, can be thermoplastically processed into shaped articles. Examples of forming methods include but are not limited to thermoforming (e.g., accuforming), vacuum forming, pressure forming, hydroforming, drape forming, pressure forming, embossing, injection molding, compression molding, gas assist molding, foam molding, injection compression molding, suck and blow molding, and blow molding.

It would also be feasible to first shape the substrate by any of the above mentioned forming methods or other methods and then post apply the coating via methods including but not limited to two component spray coating, spin coating (without recycle of excess coating, and combinations comprising at least one of the foregoing.

The substrates comprise formable materials, such as materials that can later be used in processes such as in-mold decoration to form 3D articles. Possible substrate materials include polyacrylate (e.g., poly(alkyl)methacrylates), polycarbonate, polybutylene terephalate, polypropylene, acrylonitrile-butadiene-styrene (ABS), acrylic-styrene-acrylonitrile (ASA), polyester (e.g., PBT, PET), polyamides, polyethylene (e.g., low density polyethylene (LDPE), high density polyethylene (HDPE)), polyamides, phenylene sulfide resins, polyvinyl chloride (PVC), polystyrene (e.g., high impact polystyrene (HIPS)), polypropylene (PP), polyphenylene ether resins, acrylonitrile-(ethylene-polypropylene diamine modified)-styrene (AES), thermopolymer olefins (TPO), and combinations comprising at least one of the foregoing, e.g., copolycarbonates, and polyester-polycarbonates. For example, the substrate can comprise polycarbonate/ABS blend (CYCOLOY* resins commercially available from SABIC Innovative Polymers), a copolycarbonate-polyester, acrylic-styrene-acrylonitrile (ASA) (GELOY* resins commercially available from SABIC Innovative Polymers), blends of polyphenylene ether/polyamide (NORYL GTX* resins from SABIC Innovative Polymers), blends of polycarbonate/polyethylene terephthalate (PET)/polybutylene terephthalate (PBT), polybutylene terephthalate and impact modifier (XENOY* resins commercially available from SABIC Innovative Polymers), polycarbonate (LEXAN* and LEXAN* EXL resins commercially available from SABIC Innovative Polymers), poly(methyl)meth acrylate (PMMA) capped polycarbonate, as well as combinations comprising at least one of the foregoing. The substrate can be transparent or opaque depending upon the final use of the article. Specifically, the material can be polycarbonate, polyester, and combinations comprising at least one of these materials.

The dimensions of the substrate are dependent upon the desired final product. For example, the substrate can have a thickness of less than or equal to 1 inch (25.4 mm), specifically, less than or equal to 0.5 inches (12.7 mm), more specifically, less than or equal to 30 mil (about 0.76 mm), even more specifically less than or equal to 20 mil (about 0.51 mm) For example, the thickness can be 1 mil (0.03 mm) to 50 mil (1.27 mm), specifically, 0.2 mil (0.005 mm) to 30 mil (0.76 mm)

### Additives

In addition to the components described hereinabove, the polyurethane coating and/or the substrate can further include various additive(s) that do not adversely affect the desired properties of the coating or substrate. Typical additives include, but are not limited to: rheological additives, heat stabilizers, ultraviolet light (UV) stabilizers, UV absorbers, fillers, reinforcing agents, antioxidants, color stabilizers, light stabilizers, polymerizers, lubricants, mold release agents, colorants, dyes, antistatic agents, flame retardants, anti-drip agents, gamma stabilizers, impact modifiers, X-ray contrast agents, as well as combinations comprising at least one of the foregoing. The additives usually comprise a total of less than or equal to one part per hundred by weight of the coating or substrate.

Rheological agents can be added to increase film thickness without increasing solids, to stabilize the coatings, and/or to control slip, flow, and/or leveling difficulties. Examples of rheological agents include, but are not limited to, ethyl cellulose, methyl cellulose, associative PUR* thickeners, anti-mar agents, and combinations comprising at least one of the foregoing. Examples can include DC 28* distributed by Dow Corning, or L-7602* and L-7608* obtained from Crompton of Pittsburgh, Pa., some of which are polyether silicone flow/level agents.

The relative amount of each component of the mixture will depend on the particular type of polycarbonate(s) used, the presence of any other resins, as well as the desired properties of the composition.

### Process

The coating method can be any method that employs a short dwell time, as the pot life of the unblocked isocyanate and the polyol is necessarily short (e.g., 10 to 15 minutes at 45 to 50 wt % solids), due to the fast reaction kinetics of the polymerization of the polyurethane. The coating methods used would be chosen so that residual coating would not build up or stagnate, e.g., causing a gelation of the coating and defects resulting from the blockage. Methods that have any stagnation, recycle, and/or reapplication will not work due to the fast gel time of the mixture. Examples of coating methods include slot die coating, two component spray coating, spin coating, and other one way flow applications. Generally slot die coating is employed.

In any of these coating methods, the coater has a structure in which a dual component die head is connected to two separate tanks that comprise the isocyanate component in one and the polyol component in the other, wherein the catalyst can be mixed into the polyol component tank or added at any point up to when the isocyanate and the polyol component are mixed. The isocyanate component and the polyol component are pumped into the dual component die head, which comprises a mixer, where the two components are therein mixed to form a coating mixture. Residence time from when the isocyanate component and the polyol component are combined, (e.g., in the mixer (e.g., a static mixer) and slot die) until application, is less than the gel time for the mixture, specifically less than or equal to 6 minutes, more specifically, less than or equal to 3 minutes, even more specifically, less than or equal to 60 seconds, still more specifically, less than or equal to 45 seconds, and yet more specifically, less than or equal to 30 seconds, and still more specifically, less than or equal to 15 seconds.

The coating mixture is deposited onto a substrate to form a coating. For example, the coating mixture is ejected onto a substrate from a slit gap. Relative motion is created between the coating mixture and the substrate (e.g., the substrate is in motion relative to the depositing coating and/or the die head is in motion relative to the substrate) making it possible for continuous deposition of the coating mixture. For example, the substrate can be on a rotary roller, wherein the substrate velocity is 10 feet per minute (ft/min; 3.0 meters per minute (m/min)) to 35 ft/min (10.7 m/min) so that the coating mixture is only on the substrate for 10 to 15 seconds to ensure that the dwell time before curing is short. The dwell time can be less than or equal to 180 seconds, specifically less than or equal to 120 seconds, more specifically less than or equal to 60 seconds, and even more specifically less than or equal to 15 seconds.

The concentration of solids in the isocyanate component is generally 20 wt % to 40 wt %, based upon hydroxyl equivalents to isocyanate equivalents at a one to one blend ratio. The concentration of solids in the polyol component is generally 20 wt % to 40 wt %, based upon hydroxyl equivalents to isocyanate equivalents at a one to one blend ratio.

After the coating is formed on the substrate, a drying process can be implemented (e.g., to remove solvent which remains in the coating and/or to facilitate curing), to form the final polyurethane coated substrate. Optionally, the coated substrate can be masked, e.g., after cooling (actively and/or passively). The drying can be accomplished passively (e.g., allowing drying naturally) or actively, e.g., by heating, blowing (such as air blowing, hot air blowing). For example, a three zone, high velocity oven can be employed, wherein high velocity air is blown onto the coating surface. The temperature in the oven can be 205° F. to 305° F. (about 96° C. to about 152° C.). At these temperatures, the substrate can be dried in the oven in 30 to 40 seconds or less.

The process can be performed in an inert environment, e.g., in order to reduce the amount of water in the air. For example, the process can be performed under nitrogen.

The coated substrates can then be used as desired, for example, for molding applications. Some possible molding applications include thermoforming, drapeforming, pressure forming, and in-mold decoration, e.g., with standard injection molding or with injection compression. Due to the fast cure times, these coatings can be used with polymer substrates without adversely affecting the substrate. In one embodiment the coated substrate is used in an in-mold decorating process, wherein the coated substrate is formed into a three-dimensional shape and placed into a mold. Molten resin is then injected into the mold cavity space behind the formed substrate (e.g., on a side of the substrate opposite the coating) to form a single molded part. Optionally, the coated substrate can be located on both sides of the resin (e.g., the resin is injected between two coated substrates).

The polyurethane coatings can have greater than or equal to 90%, specifically 95% conversion of the isocyanate (NCO) due to the unblocked chemistry (as measured by percent isocyanate consumption via infrared (IR) analysis immediately after the bake cycle) and fast reaction rates. This is beneficial over current polyurethane coating methods as there is less residual isocyanate that would otherwise act as a plasticizer and be detrimental to the cured film and/or increase the amount of urea formation in the film. Lower isocyanate conversion results in increased urea formation which results in decreased mechanical properties such as Taber delta haze, hardness, and chemical resistance.

The polyurethane coatings can have a thickness of greater than or equal to 5 micrometers (μm), specifically, 9 to 15 micormeters, and more specifically, 11 to 12 micormeters.

The following examples are provided to illustrate the polyurethane coating and methods of the present disclosure. The examples are merely illustrative and are not intended to limit devices made in accordance with the disclosure to the materials, conditions, or process parameters set forth therein.

### Embodiment 1

A method of making a polyurethane coating comprises: mixing an unblocked isocyanate component with a polyol component in the presence of a hydroxyl-free solvent and a catalyst to form a reaction mixture; depositing the reaction mixture onto a polymer substrate; and curing the reaction mixture on the substrate to form a polyurethane coated substrate. The polyurethane coated substrate has a percent thinning of greater than or equal to 10% without cracking or delamination when measured on a rectangular block having 90° sides, (e.g., without cracking or delamination when formed over a rectangular block having 90° angles).

### Embodiment 2

The method of Embodiment 1, further comprising forming the polyurethane coated substrate, wherein the polyurethane coated substrate is thinned by greater than 10%.

### Embodiment 3

The method of Embodiment 2, wherein the forming is at least one of thermoforming, drapeforming, pressure forming, and in-mold decoration.

### Embodiment 4

A method of making a polyurethane coated substrates can comprise: mixing an unblocked isocyanate component with a polyol component in the presence of a hydroxyl-free solvent and a catalyst to form a reaction mixture; depositing the reaction mixture onto a polymer substrate; curing the reaction mixture on the substrate to form a polyurethane coated substrate; and thinning the polyurethane coated substrate, wherein the polyurethane coated substrate is thinned by greater than or equal to 10%.

### Embodiment 5

The method of Embodiment 4, wherein the thinning is accomplished by at least one of thermoforming, drapeforming, pressure forming, and in-mold decoration.

### Embodiment 6

The method of any of Embodiments 1-5, wherein the curing occurs in a period of less than or equal to 60 seconds.

### Embodiment 7

The method of any of Embodiments 1-6, wherein the curing is greater than or equal to 90% conversion of the isocyanate.

### Embodiment 8

The method of any of Embodiments 1-7, wherein the curing is a single cure with greater than or equal to 95% conversion of the isocyanate component.

### Embodiment 9

The method of any of Embodiments 1-8, wherein the curing is to a greater than or equal to 98% isocyanate conversion.

### Embodiment 10

The method of any of Embodiments 1-9, wherein the hydroxyl-free solvent comprises a ketone.

### Embodiment 11

The method of any of Embodiments 1-10, wherein the hydroxy-free solvent comprises methyl ethyl ketone.

### Embodiment 12

The method of any of Embodiments 1-11, wherein the percent thinning is greater than or equal to 15%.

### Embodiment 13

The method of any of Embodiments 1-12, wherein the percent thinning is greater than or equal to 35%.

### Embodiment 14

The method of any of Embodiments 1-13, wherein the catalyst comprises dibutyl tin dilaurate.

### Embodiment 15

The method of any of Embodiments 1-14, wherein the isocyanate component is greater than or equal to 90% unblocked, based upon the total weight of the isocyanate.

### Embodiment 16

The method of any of Embodiments 1-15, wherein the isocyanate component is greater than or equal to 95% unblocked, based upon the total weight of the isocyanate.

### Embodiment 17

The method of any of Embodiments 1-16, wherein the polyol component has a hydroxyl equivalent weight of 100 to 900.

### Embodiment 18

The method of any of Embodiments 1-17, wherein a residence time from when the isocyanate component and the polyol component are combined, until application to the polymer substrate is less than a gel time for the reaction mixture.

### Embodiment 19

The method of any of Embodiments 1-18, wherein a residence time from when the isocyanate component and the polyol component are combined, until application to the polymer substrate is less than or equal to 6 minutes.

### Embodiment 20

The method of any of Embodiments 1-19, wherein a residence time from when the isocyanate component and the polyol component are combined, until application to the polymer substrate is less than or equal to 3 minutes.

### Embodiment 21

The method of any of Embodiments 1-20, wherein a residence time from when the isocyanate component and the polyol component are combined, until application to the polymer substrate is less than or equal to 60 seconds.

### Embodiment 22

The method of any of Embodiments 1-21, wherein a residence time from when the isocyanate component and the polyol component are combined, until application to the polymer substrate is less than or equal to 45 seconds.

### Embodiment 23

The method of any of Embodiments 1-22, wherein a residence time from when the isocyanate component and the polyol component are combined, until application to the polymer substrate is less than or equal to 30 seconds.

### Embodiment 24

The method of any of Embodiments 1-23, wherein a residence time from when the isocyanate component and the polyol component are combined, until application to the polymer substrate is less than or equal to 15 seconds.

### Embodiment 25

The method of any of Embodiments 1-24, wherein the substrate comprises polycarbonate.

### Embodiment 26

The method of any of Embodiments 1-25, wherein the polyol component comprises at least one of polyethylene glycol and polypropylene glycol.

### Embodiment 27

The method of any of Embodiments 1-26, wherein the polyol component comprises polyoxyethylene glycol.

### Embodiment 28

The method of any of Embodiments 1-27, wherein the isocyanate comprises hexamethylene diisocyanate, toluene diisocyanate, or a combination comprising at least one of hexamethylene diisocyanate and toluene diisocyanate.

### Embodiment 29

The method of any of Embodiments 1-28, wherein the coating on the polyurethane coated substrate has a delta haze after Taber of less than or equal to 10%, as determined in accordance with ASTM D1044-08 using CS-10F wheels, a 500 gram load, and 100 cycles.

### Embodiment 30

The method of any of Embodiments 1-29, wherein the isocyanate component comprises at least one of unblocked hexamethylene diisocyanate and unblocked diisophorone diisocyanate.

### Embodiment 31

The method of any of Embodiments 1-30, wherein the isocyanate component comprises hexamethylene diisocyanate.

### Embodiment 32

An article formed by the method of any of Embodiments 1-31.

### EXAMPLES

### Test Procedures

Chemical resistance was determined via spot testing, wherein a drop of liquid was placed on the coating surface for either a 1 hour (hr) or 24 hour exposure. Any haze, white blushing, deformation, mark, or residual water mark, visible to the unaided eye with normal vision, resulted in a test failure. A sample passed the spot test if there was no visual indication that the liquid had been placed on the surface.

Fog resistance was determined by time to fog tests and fog behavior at saturation. Time to fog was determined by a water soak of the coated film for one hour in ambient temperature water, followed by one hour recovery time at standard laboratory conditions prior to testing.

Haze (%) was determined according to ASTM D1003-00, Procedure A, illuminant C, using a Gardner Haze Guard Dual, on 3.2 millimeter thick molded plaques.

Delta haze after Taber was measured according to ASTM D1044-08. The original haze of a 4 inch diameter sample with a 0.25 inch diameter hole cut out of the middle was determined and placed on the abrasion tester. A 500 gram (g) load was placed on top of the CS 10F abrader wheel and allowed to spin for 100 revolutions. The haze of the final sample was determined and the percent increase in haze was determined.

Scratch resistance was measured using the Pencil Hardness Test according to ASTM D3363-92a, which describes a procedure for rapid, inexpensive determination of the film hardness of an organic coating on a substrate in terms of drawing leads or pencil leads of known hardness ranging in order of softest to hardest: 6B, 5B, 4B, 3B, 2B, B, HB, F, H, 2H, 3H, 4H, 5H, 6H. In the method, a coated panel (or other test substrate) is placed on a firm horizontal surface. The pencil is held firmly against the film or substrate at a 45 degree angle (with the point directed away from the operator) and pushed away from the operator in a single stroke of 6.5 mm in length. The process is started with the hardest pencil and continued down the scale of hardness to either of two end points; one, the pencil that will not cut into or gouge the film (pencil hardness), or two, the pencil that will not scratch the film (scratch hardness). Higher pencil hardness and shallower scratches (lower scratch depths) indicate better scratch resistance.

Percent thinning was determined in accordance with the following equation

$$percent thinning = ( \frac{original thickness - thickness after forming}{original thickness} ) \times 100$$

The components used in the examples were Exxene HCAF424, where the isocyanate package is unblocked and solvated with MEK/MIBK, and the catalyst was dibutyl tin dilaurate.

### Example 1

### Polyurethane Coating Prepared by Roll-To-Roll Processing

Polyurethane films were prepared from the unblocked isocyanate (an unblocked version of Exxene HCAF 424 Component A) and the polyol (Exxene HCAF 424 Component B). A dibutyl tin dilaurate catalyst was combined with Component B prior to introduction to the static mixer. The Components A and B were pumped separately to a static mixer where they were combined and mixed to form a reaction mixture while being pumped to the slot die coater head. The reaction mixture was applied to the substrate (a 10 mil polycarbonate film) via a roll-to-roll processing technique. The substrate velocity was at 30 ft/min (9.1 m/min), so that the mixed components were only on the substrate for 10 to 15 seconds to ensure that the dwell time before curing was extremely short. After deposition of the mixed components onto the substrate, the substrate entered a three zone high velocity oven, wherein high velocity air is blown down onto the surface. The temperature in the oven ranged from 205° F. to 305° F. (96° C. to 152° C.), and the substrate was only in the oven for 35 seconds.

### Comparative Example 2

### Polyurethane Coating Prepared Via in Accordance with Example 1

Polyurethane films were prepared via using the times, oven temperatures, and rates set forth in Example 1, but employing VISGARD* coating. The resultant coated substrate was undercured which caused the problems set forth below.

### Example 3

### Chemical Resistance, One Hour Exposure

The chemical resistance after one hour exposure to the polyurethane coating of Example 1 was determined.

TABLE 1

| Liquid | Result |
|---|---|
| Acetone | Fail |
| Methyl ethyl ketone | Fail |
| Toluene | Fail |
| Methylene chloride | Fail |
| Isopropyl alcohol | Pass, slight |
| Cyclohexane | Pass |
| Ethyl acetate | Fail |
| 40% sodium hydroxide | Pass |
| Concentrated hydrochloric acid | Pass |
| Gasoline | Pass |
| Butyl cellosolve | Pass, slight |

Table 1 shows that the polyurethane coatings were resistant after a one hour exposure to cyclohexane, 40% sodium hydroxide, concentrated hydrochloric acid, gasoline and were somewhat resistant to isopropyl alcohol and butyl cellosolve.

### Example 4

### Chemical Resistance, 24 Hour Exposure

The chemical resistance after 24 hours of exposure to the polyurethane coating of Example 1 was determined.

TABLE 2

| Liquid | Result |
|---|---|
| Coffee | Pass |
| FORMULA 409* | Pass |
| WINDEX* | Pass |
| Mustard | Fail |
| Ketchup | Pass |
| Tea | Pass |
| Lemon juice | Fail |
| SPF15 sunscreen | Pass |
| DIAMLER* sunscreen | Pass, slight |

Table 2 shows that the polyurethane coatings were resistant after a 24 hour exposure to coffee, FORMULA 409*, WINDEX*, ketchup, tea, SPF15 sunscreen, and were somewhat resistant to DIAMLER* sunscreen.

### Examples 5 and 6

### Time to Fog

### Example 5

Time to fog experiment was performed on the coating of Example 1 resulting in a time to fog value of greater than 110 seconds.

### Example 6

Time to fog experiment was performed on the coating of Comparative Example 2, resulting in a time to fog value of only 15-30 seconds.

The coating of the present application resulted in an improved time to fog value of more than three times that of the coating of Comparative Example 2.

### Examples 7 and 8

### Taber Haze

### Example 7

Taber haze experiment was performed on the coating of Example 1, resulting in a delta haze after Taber of 4-6%.

### Example 8

Taber haze experiment was performed on the coating of Comparative Example 2, resulting in a delta haze after Taber of 10-15%.

The coating of the present application resulted in an improved Taber haze as compared to the coating of Comparative Example 2 of a decrease of more than half.

### Examples 9 and 10

### Pencil Hardness

### Example 9

Pencil hardness experiment was performed on the coating of Example 1, resulting in a Pencil hardness of F.

### Example 10

Pencil hardness experiment was performed on the coating of Comparative Example 2, resulting in a Pencil hardness of B-HB.

The coating of Example 1 resulted in an improved scratch resistance as compared to the coating of Comparative Example 2.

### Examples 11 and 12

### Fog Behavior at Saturation

### Example 11

Fog behavior at saturation was performed for the coating of Example 1, resulting in droplet formation on the coating.

### Example 12

Fog behavior at saturation was performed for the coating of Comparative Example 2, resulting in a uniform mist on the coating.

### Examples 13-24

### Percent Thinning

Percent thinning experiments were performed on the coatings of Example 1 using the substrates as set forth in Table 3, using a phone tool. None of the samples exhibited delamination (DL) and they all retained the anti-fog performance (AF). Samples formed using the VISGARD as set forth in Comparative Example 2 did not exhibit thinning.

TABLE 3
(Phone Tool)

| | | Initial | Final | |
|---|---|---|---|---|
| | | thickness | Thickness | Thinning |
| # | Sample¹ (thickness) | (mm) | (mm)* | (%) |
| 13 | PMMA/PC | 0.29845 | 0.2413 | 19.14894 |
| | 10 mil (0.254 mm) | | | |
| 14 | PMMA/PC | 0.22225 | 0.1905 | 14.28571 |
| | 7 mil (0.179 mm) | | | |
| 15 | PC 15 mil (0.381 mm) | 0.4191 | 0.35814 | 14.54545 |
| 16 | PC 7 mil (0.179 mm) | 0.22606 | 0.20066 | 11.23596 |
| 17 | PC 10 mil (0.254 mm) | 0.28194 | 0.2286 | 18.91892 |
| 18 | PC 20 mil (0.508 mm) | 0.56134 | 0.48006 | 14.47964 |

¹polyurethane coating of Example 1 on the identified substrate having the specified thickness
*Final thickness just before delamination

Percent thinning experiments were performed on the coatings of Example 1 using the substrates as set forth in Table 4, in a 6 block tool. None of the samples exhibited delamination (DL) and they all retained the anti-fog performance (AF).

TABLE 4
(6 Block Tool)

| | | Initial | Final | |
|---|---|---|---|---|
| | | thickness | Thickness | Thinning |
| # | Sample¹ (thickness) | (mm) | (mm)* | (%) |
| 19 | PMMA/PC | 0.28194 | 0.1905 | 32.43243 |
| | 10 mil (0.254 mm) | | | |
| 20 | PMMA/PC | 0.20955 | 0.14224 | 32.12121 |
| | 7 mil (0.179 mm) | | | |
| 21 | PC 15 mil (0.381 mm) | 0.4064 | 0.29972 | 26.25 |
| 22 | PC 7 mil (0.179 mm) | 0.2159 | 0.1397 | 35.29412 |
| 23 | PC 10 mil (0.254 mm) | 0.2921 | 0.1905 | 34.78261 |
| 24 | PC 20 mil (0.508 mm) | 0.55626 | 0.3937 | 29.22374 |

*Final thickness just before delamination.
¹polyurethane coating of Example 1 on the identified substrate having the specified thickness

The coated film disclosed herein has a cured coating (e.g., greater than 95% conversion of the isocyanate) and yet is formable. In other words, even with the cured coating, the coated film has a percent thinning of greater than or equal to 10% without cracking or delamination when formed over a rectangle having 90° sides. Desirably the percent thinning is greater than or equal to 15%, specifically, greater than or equal to 25%, more specifically greater than or equal to 35%, and even greater than or equal to 50%, without cracking or delamination.

While the disclosure has been described with reference to an exemplary embodiment, it will be understood by those skilled in the art that various changes can be made and equivalents can be substituted for elements thereof without departing from the scope of the disclosure. In addition, many modifications can be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

### Terminology

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The endpoints of all ranges directed to the same component or property are inclusive of the endpoint and independently combinable. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Unless otherwise defined, all terms (including technical and scientific terms) used herein have the same meaning as commonly understood by one of ordinary skill in the art to which this disclosure belongs.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. Alkyl groups can be straight-chained or branched. Throughout the specification, reference is made to various bivalent groups. Such groups are the same as the monovalent groups that are similarly named, and are typically indicated with an “ene” suffix. For example, a C₁ to C₆ alkylene group is a bivalent linking group having the same structure as a C₁ to C₆ alkyl group.

Unless otherwise indicated, each of the foregoing groups can be unsubstituted or substituted, provided that the substitution does not significantly adversely affect synthesis, stability, or use of the compound. The term “substituted” as used herein means that any one or more hydrogens on the designated atom or group are replaced with another group, provided that the designated atom's normal valence is not exceeded. When the substituent is oxo (i.e., ═O), then two hydrogens on the atom are replaced. Combinations of substituents and/or variables are permissible provided that the substitutions do not significantly adversely affect synthesis or use of the compound.

“Isocyanate” refers to compounds that comprise one or more of the functional group —N═C═O. “Polyol” refers to compounds that contain multiple hydroxyl groups. “Polyurethane” refers to a polymer chain that comprises carbamate or urethane links that are characterized by —O—(C═O)—(NH)—.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein the term “pot-life” refers to the amount of time it takes for an isocyanate/polyol system to fully react, wherein blocked isocyanate systems can have as much as 8 to 12 hours as compared to unblocked isocyanate systems that generally have pot-lives of more than an order of magnitude less. The term “weight percent (wt %) on resin” refers to the weight percent of a component relative to the total amount of resin.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Various combinations of elements of this disclosure are encompassed by this disclosure, e.g. combinations of elements from dependent claims that depend upon the same independent claim.

What is claimed is:

1. A method of making a polyurethane coating comprises:
mixing an unblocked isocyanate component with a polyol component in the presence of a hydroxyl-free solvent and a catalyst to form a reaction mixture;
depositing the reaction mixture onto a polymer substrate; and
curing the reaction mixture on the substrate to form a polyurethane coated substrate;
wherein the polyurethane coated substrate has a percent thinning of greater than or equal to 10% when formed over a rectangular block having 90° angles.

2. The method of claim 1, wherein the curing occurs in a period of less than or equal to 60 seconds.

3. The method of claim 1, wherein the hydroxyl-free solvent comprises a ketone.

4. The method of claim 3, wherein the hydroxy-free solvent comprises methyl ethyl ketone.

5. The method of claim 1, wherein the percent thinning is greater than or equal to 15%.

6. The method of claim 5, wherein the percent thinning is greater than or equal to 35%.

7. The method of claim 1, wherein the catalyst comprises dibutyl tin dilaurate.

8. The method of claim 1, wherein the isocyanate component is greater than or equal to 90% unblocked, based upon the total weight of the isocyanate component.

9. The method of claim 8, wherein the isocyanate component is greater than or equal to 95% unblocked, based upon the total weight of the isocyanate component.

10. The method of claim 1, wherein the polyol component has a hydroxyl equivalent weight of 100 to 900.

11. The method of claim 1, wherein a residence time from when the isocyanate component and the polyol component are combined, until application to the polymer substrate is less than a gel time for the reaction mixture.

12. The method of claim 11, wherein the residence time is less than or equal to 6 minutes.

13. The method of claim 12, wherein the residence time is less than or equal to 60 seconds.

14. The method of claim 1, wherein the substrate comprises polycarbonate.

15. The method of claim 1, wherein the polyol component comprises at least one of polyethylene glycol and polypropylene glycol.

16. The method of claim 15, wherein the polyol component comprises polyoxyethylene glycol.

17. The method of claim 1, wherein the isocyanate component comprises hexamethylene diisocyanate, toluene diisocyanate, or a combination comprising at least one of hexamethylene diisocyanate and toluene diisocyanate.

18. The method of claim 1, wherein the coating on the polyurethane coated substrate has a delta haze after Taber of less than or equal to 10%, as determined in accordance with ASTM D1044-08 using CS-10F wheels, a 500 gram load, and 100 cycles.

19. The method of claim 1, further comprising forming the polyurethane coated substrate, wherein the polyurethane coated substrate is thinned by greater than 10%.

20. The method of claim 19, wherein the forming is at least one of thermoforming, drapeforming, pressure forming, and in-mold decoration.

21. The method of claim 1, wherein the isocyanate component is solvated in methy ethyl keytone and methyl isobutyl ketone.

22. The method of claim 1, wherein the curing is a single cure with greater than or equal to 95% conversion of the isocyanate component.

23. The method of claim 1, wherein the isocyanate component comprises hexamethylene diisocyanate.

24. A method of making a polyurethane coating comprises:
mixing an unblocked isocyanate component with a polyol component in the presence of a hydroxyl-free solvent and a catalyst to form a reaction mixture;
depositing the reaction mixture onto a polymer substrate;
curing the reaction mixture on the substrate to form a polyurethane coated substrate; and
thinning the polyurethane coated substrate, wherein the polyurethane coated substrate is thinned by greater than or equal to 10%.

25. An article formed by the method of claim 24.
